(19) United States
(12) Patent Application Publication
(10) Pub. No.: US 2007/0000524 A1
(43) Pub. Date: Jan. 4, 2007

(54) Substrate processing apparatus and substrate processing method

(75) Inventor: Masahiro Kimura, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/480,148

(22) Filed: Jun. 30, 2006

(30) Foreign Application Priority Data
Jun. 30, 2005 (JP) JP2005-191457

(51) Int. Cl. B08B 7/00

(52) U.S. Cl. 134/42

(57) ABSTRACT

Carbon dioxide is dissolved in deionized water by the application of pressure to generate a carbon-dioxide-dissolved rinse. Substrates are immersed in a processing bath which retains the carbon-dioxide-dissolved rinse, and then lifted out of the processing bath in a chamber which is in an atmosphere of an IPA gas for drying. This can control the occurrence of problems resulting from remaining water between traces on a fine pattern, such as falling-down of cylinders, poor drying in trenches, and the like.

### BACKGROUND OF THE INVENTION

1. Field of the Invention

The present invention relates to a technique for drying substrates after surface cleaning of the substrates with a rinse in a substrate processing apparatus for making surface preparation on substrates such as semiconductor substrates, glass substrates for liquid crystal displays, glass substrates for photomasks, etc. (hereinafter briefly referred to as “substrates”).

2. Description of the Background Art

A substrate processing apparatus has conventionally been known in which, in the manufacturing process of semiconductor substrates, substrates having been treated with a liquid chemical are cleaned with deionized water, and then, a gaseous organic solvent such as isopropyl alcohol (hereinafter briefly referred to as “IPA”) is supplied in the vicinity of the substrates while lifting the substrates out of deionized water, to thereby dry the substrates (disclosed in, e.g., Japanese Patent Application Laid-Open No. 2001-291698).

With the trend of recent years toward a finer and more complicate pattern formed on a substrate, water droplets are more likely to remain between traces on the fine pattern formed on a substrate when lifting the substrate after cleaning with deionized water. Further, metallization of the capacitor surface and the like has advanced recently. Since metal has a higher wettability than polyethylene which has conventionally been used for the capacitor surface, water droplets are more likely to remain between metal-surfaced capacitors. That is, in addition to finer and more complicated patterning, the metallization of the pattern surface also causes more and more water to remain between traces on the pattern. Such remaining water between traces on the pattern raises various problems in the drying step of substrates.

An example of such various problems is falling-down of cylinder-type capacitors. FIGS. 12 and 13 show falling-down of cylinders resulting from unevenly remaining water L occurring between cylinder-type capacitors S1, S2 and S3 formed on a substrate. Such unevenly remaining water L as shown in FIG. 12, if occurred when lifting a substrate out of deionized water, causes a force F biased in a specific direction as a composite of nonuniform forces f1 and f2 resulting from the surface tension to be exerted on the cylinder-type capacitor S2. This results in falling-down of the cylinders as shown in FIG. 13 in the drying step. With the recent trend toward narrower intervals between cylinders, such unevenly remaining water L is more likely to occur, causing the falling-down of cylinders to be a serious problem.

Another problem is poor drying in trench-type capacitors, for example. Water remaining in trenches when lifting substrates out of deionized water is difficult to remove in the subsequent drying step, which is likely to cause poor drying. With the recent trend toward narrower trenches, remaining water in trenches is more likely to occur, and drying of the trenches is becoming increasingly difficult. Therefore, the poor drying in trenches also raises a serious issue.

### SUMMARY OF THE INVENTION

The present invention is directed to a substrate processing apparatus for making surface preparation on a substrate.

According to a first aspect of the present invention, the substrate processing apparatus comprises: a chamber being able to be sealed while holding a substrate therein; a processing bath being provided in the chamber and being able to retain a rinse; a rinse preparing element bringing a rinse obtained by dissolving carbon dioxide in deionized water to be retained in the processing bath; a lifter holding and moving up and down the substrate between an immersed position in which the substrate is immersed in the rinse retained in the processing bath and a raised position above the processing bath in the chamber; and a gaseous organic solvent supplier supplying a gaseous organic solvent into the chamber when relatively lifting the substrate having been subjected to surface cleaning with the rinse in the processing bath from a liquid surface of the rinse with the substrate being held by the lifter.

According to a second aspect of the present invention, the substrate processing apparatus comprises: a holding mechanism holding a substrate; a rotation driving source rotating the holding mechanism to thereby rotate the substrate held by the holding mechanism; a rinse supplier supplying a rinse obtained by dissolving carbon dioxide in deionized water to the substrate held by the holding mechanism; and a gaseous organic solvent supplier supplying a gaseous organic solvent to the substrate held by the holding mechanism after surface cleaning of the substrate with the rinse is finished.

According to a third aspect of the present invention, the substrate processing apparatus comprises: a chamber being able to be sealed while holding a substrate therein; a processing bath being provided in the chamber and being able to retain a rinse; a rinse preparing element bringing a rinse obtained by dissolving hydrogen in deionized water to be retained in the processing bath; a lifter holding and moving up and down the substrate between an immersed position in which the substrate is immersed in the rinse retained in the processing bath and a raised position above the processing bath in the chamber; and a gaseous organic solvent supplier supplying a gaseous organic solvent into the chamber when relatively lifting the substrate having been subjected to surface cleaning with the rinse in the processing bath from a liquid surface of the rinse with the substrate being held by the lifter.

According to a fourth aspect of the present invention, the substrate processing apparatus comprises: a holding mechanism holding a substrate; a rotation driving source rotating the holding mechanism to thereby rotate the substrate held by the holding mechanism; a rinse supplier supplying a rinse obtained by dissolving hydrogen in deionized water to the substrate held by the holding mechanism; and a gaseous organic solvent supplier supplying a gaseous organic solvent to the substrate held by the holding mechanism after surface cleaning of the substrate with the rinse is finished.

The amount of rinse remaining between traces on a pattern formed on the surface of a substrate when surface cleaning of the substrate with the rinse is finished is smaller than in the case of using deionized water as a rinse. Therefore, problems resulting from remaining water between traces on a pattern in the drying step are less likely to occur.

It is therefore an object of the present invention to provide a technique capable of controlling the occurrence of problems resulting from remaining water between traces on a pattern formed on the substrate surface in the drying step of the substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a vertical sectional view illustrating a substrate processing apparatus according to a first preferred embodiment taken along a plane parallel to substrates;

FIG. 2 is a vertical sectional view illustrating the substrate processing apparatus according to the first preferred embodiment;

FIGS. 3 to 5 illustrate an operation of the substrate processing apparatus according to the first preferred embodiment;

FIG. 6 is a vertical sectional view illustrating a substrate processing apparatus according to a second preferred embodiment;

FIGS. 7 to 9 illustrate an operation of the substrate processing apparatus according to the second preferred embodiment;

FIG. 10 illustrates a processing liquid supply system according to a third preferred embodiment;

FIG. 11 illustrates a processing liquid supply system according to a fourth preferred embodiment;

FIGS. 12 and 13 illustrate falling-down of cylinders resulting from unevenly remaining water occurring between cylinder-type capacitors; and

FIGS. 14 and 15 illustrate how falling-down of the cylinders is controlled when unevenly remaining water does not occur between the cylinder-type capacitors.

### DESCRIPTION OF THE PREFERRED EMBODIMENTS

### First Preferred Embodiment

1-1. Arrangement of Substrate Processing Apparatus 1

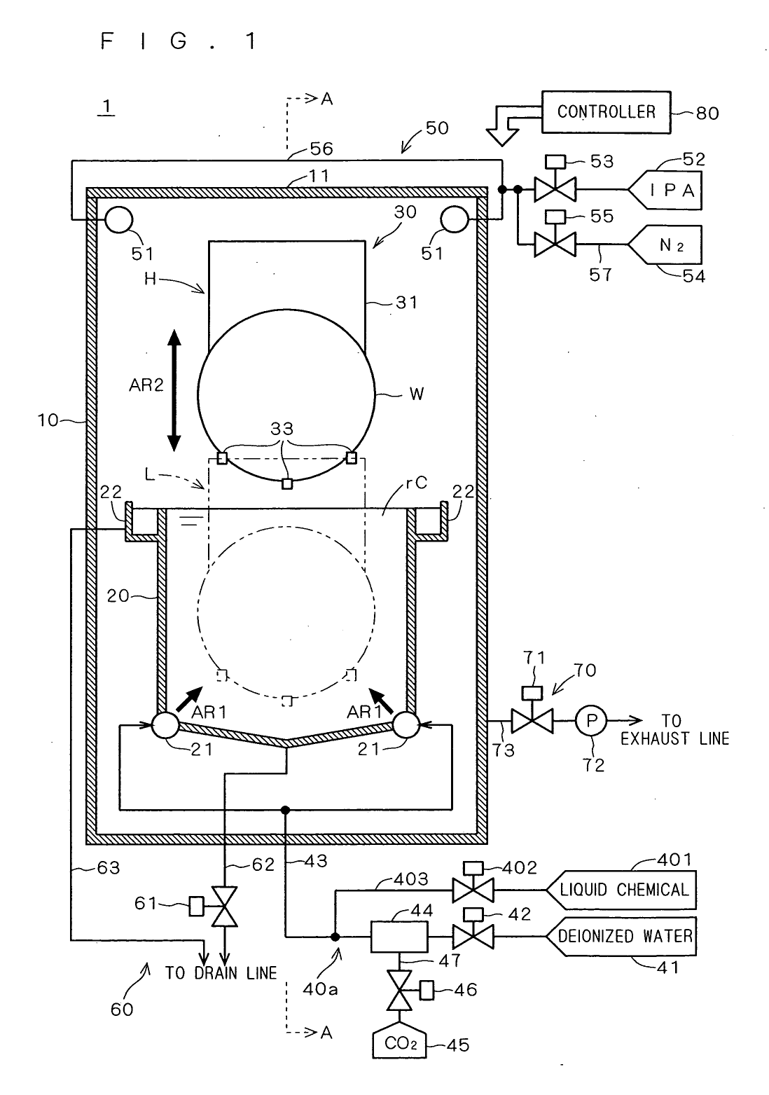

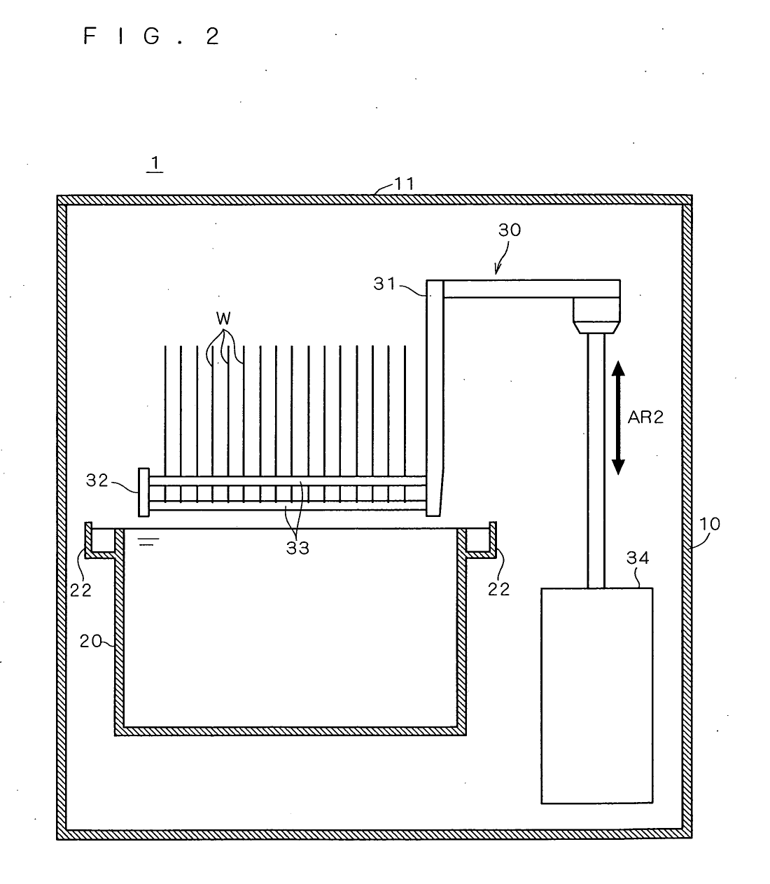

A first preferred embodiment describes the application of the present invention to a batch-type substrate processing apparatus. FIG. 1 is a vertical sectional view illustrating a substrate processing apparatus 1 according to the first preferred embodiment taken along a plane parallel to substrates W. FIG. 1 also shows piping and the structure of a control system. FIG. 2 is a vertical sectional view illustrating the substrate processing apparatus 1 taken in a position A-A in FIG. 1.

The substrate processing apparatus 1 is an apparatus for treating substrates W with a liquid chemical, then carrying out surface cleaning with a rinse on the substrates W for removing the liquid chemical from the substrates W, and thereafter drying the substrates W using IPA which is an organic solvent, and mainly includes a chamber 10, a processing bath 20, a lifter 30, a processing liquid supply system 40a, a gas supply system 50, a drainage system 60, an exhaust system 70 and a controller 80.

The chamber 10 is a housing for holding therein the processing bath 20, lifter 30, a gas supply nozzle 51, and the like. An upper portion 11 of the chamber 10 can be opened/closed by a sliding open/close mechanism (not shown). With the upper portion 11 being open, substrates W can be transported through the opening, while, with the upper portion 11 being closed, the chamber 10 can be sealed.

The processing bath 20 is a reservoir for retaining a rinse as a processing liquid. Two processing liquid discharge nozzles 21 are provided near the bottom of the processing bath 20. The two processing liquid discharge nozzles 21 are respectively directed toward the side on opposite sides of substrates W immersed in the processing bath 20, and the processing liquid is discharged angularly upward from the processing liquid discharge nozzles 21 to the inside of the processing bath 20, as indicated by an arrow AR1 in FIG. 1. The top of the processing bath 20 is open, and external baths 22 are provided on the top edge of its outer surface. The processing liquid discharged from the processing liquid discharge nozzles 21 flows upward within the processing bath 20 and overflows from the upper opening to the external baths 22.

The lifter 30 is a mechanism for holding and moving up and down a plurality of substrates W, and includes a lifter head 31, a holding plate 32 and three holding bars 33. The holding bars 33 provided fixedly between the lifter head 31 and holding plate 32 each have a plurality of holding grooves (not shown) engraved thereon, and the plurality of substrates W are simultaneously held in upright positions on the holding grooves. Further, the lifter 30 is connected to a lifter driver 34 having a servo motor, a timing belt and the like. The lifter 30 moves up and down by operation of the lifter driver 34, so that the plurality of substrates W move up and down between an immersed position L (indicated with phantom line in FIG. 1) in the processing bath 20 and a raised position H (indicated with solid line in FIG. 1) above the processing bath 20 in the chamber 10, as indicated by an arrow AR2. By moving the lifter 30 upward to be located in the raised position H as well as opening the upper portion 11 of the chamber 10, substrates W can be transferred between a substrate transfer robot outside the apparatus and the lifter 30.

The processing liquid supply system 40a is piping for supplying a liquid chemical and a rinse to the processing liquid discharge nozzles 21. As piping for supplying the rinse to the processing liquid discharge nozzles 21, the processing liquid supply system 40a includes a deionized-water supply source 41, a deionized-water valve 42 and a pipe 43, and further includes a gas dissolver 44, a carbon dioxide supply source 45, a gas valve 46 and a pipe 47. Furthermore, as piping for supplying the liquid chemical to the processing liquid discharge nozzles 21, the processing liquid supply system 40a includes a liquid chemical supply source 401, a liquid chemical valve 402 and a pipe 403.

The pipe 43 with the deionized-water valve 42 interposed therein extends from the deionized-water supply source 41, and is connected to the processing liquid discharge nozzles 21. The gas dissolver 44 is interposed in the pipe 43 downstream of the deionized-water valve 42. The pipe 47 with the gas valve 46 interposed therein extends from the carbon dioxide supply source 45, and is connected to the gas dissolver 44.

The pipe 403 with the liquid chemical valve 402 interposed therein extends from the liquid chemical supply source 401. The pipe 403 joins the pipe 43 downstream of the gas dissolver 44. However, the pipe 403 may join the pipe 43 upstream of the gas dissolver 44. Although only one liquid chemical supply source 401 is illustrated here, a plurality of types of liquid chemical supply sources may be provided.

In such construction, opening the deionized-water valve 42 introduces deionized water supplied from the deionized-water supply source 41 into the gas dissolver 44. Opening the gas valve 46 introduces carbon dioxide into the gas dissolver 44. The gas dissolver 44 dissolves the supplied carbon dioxide in deionized water supplied through the pipe 43 by the application of pressure, to thereby generate a rinse. This rinse (hereinafter referred to as “carbon-dioxide-dissolved rinse rC”) generated by dissolving carbon dioxide in deionized water is supplied to the processing liquid discharge nozzles 21 through the pipe 43. The construction for obtaining the carbon-dioxide-dissolved rinse rC in the processing bath 20 is not limited to the above-described one in which the gas dissolver 44 is interposed in the pipe 43 through which deionized water flows. For instance, the processing bath 20 may be provided with a carbon dioxide supply port, and the carbon dioxide supply source 45 may be connected thereto. In that case, the carbon-dioxide-dissolved rinse rC is obtained in the processing bath 20 by blowing carbon dioxide into deionized water retained in the processing bath 20.

In the aforementioned construction, opening the liquid chemical valve 402 introduces a liquid chemical supplied from the liquid chemical supply source 401 into the processing liquid discharge nozzles 21 through the pipes 403 and 43. The liquid chemical supplied from the liquid chemical supply source 401 is for cleaning substrates W. For instance, APM (Ammonia-Hydrogen Peroxide Mixture), HPM (Hydrochloric acid-Hydrogen Peroxide Mixture), FPM (Hydrofluoric acid-Hydrogen Peroxide Mixture), DHF (Diluted Hydrofluoric Acid), O3/DIW (ozone water), or the like is selectively used as appropriate according to the type of film formed on substrates W.

The gas supply system 50 is piping for supplying a nitrogen gas and an IPA gas into the chamber 10, and includes the gas supply nozzles 51 provided on both top sides in the chamber 10 for supplying a predetermined gas angularly downward, an IPA supply source 52, an IPA valve 53, a nitrogen supply source 54, a nitrogen valve 55, and pipes 56 and 57. The pipe 56 with the IPA valve 53 interposed therein extends from the IPA supply source 52, and the pipe 57 with the nitrogen valve 55 interposed therein extends from the nitrogen supply source 54. The pipe 57 joins the pipe 56 downstream of the IPA valve 53. The joined pipe 56 is connected to the gas supply nozzles 51. In such construction, opening the IPA valve 53 discharges the IPA gas from the gas supply nozzles 51, so that the IPA gas is supplied into the chamber 10. Opening the nitrogen gas 55 discharges the nitrogen gas from the gas supply nozzles 51, so that the nitrogen gas is supplied into the chamber 10.

The drainage system 60 is piping for draining a processing liquid in the processing bath 20, and includes pipes 62 and 63, and a drainage valve 61. The pipe 62 with the drainage valve 61 interposed therein is connected to the bottom of the processing bath 20. The pipe 63 is connected to the external baths 22. In such construction, opening the drainage valve 61 quickly drains the processing liquid in the processing bath 20 to a drain line through the pipe 62. The processing liquid overflowing from the processing bath 20 into the external baths 22 is drained to the drain line through the pipe 63.

The exhaust system 70 is piping for exhausting the atmosphere in the chamber 10, and includes an exhaust valve 71, an exhaust pump 72 which is a pressure-reducing pump and a pipe 73. The exhaust valve 71 and exhaust pump 72 are interposed in the pipe 73 connected to the inside of the chamber 10. In such construction, opening the exhaust valve 71 to drive the exhaust pump 72 exhausts the atmosphere in the chamber 10. Further, when the chamber 10 is sealed, the pressure within the chamber 10 is reduced.

The controller 80 is electrically connected to the lifter driver 34, deionized-water valve 42, liquid chemical valve 402, gas valve 46, gas dissolver 44, IPA valve 53, nitrogen valve 55, drainage valve 61, exhaust valve 71, exhaust pump 72 and the like, for controlling their operations.

1-2. Substrate Processing of Substrate Processing Apparatus 1

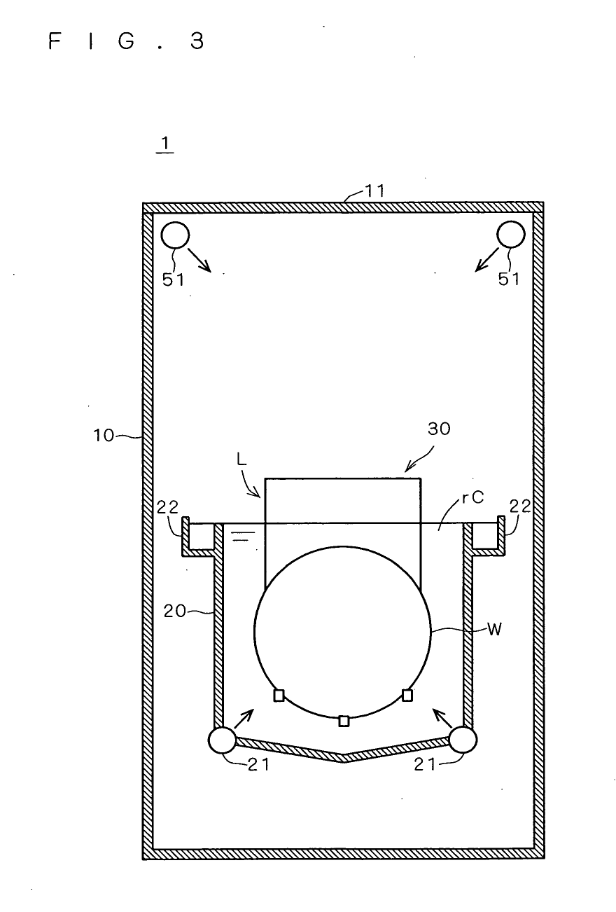

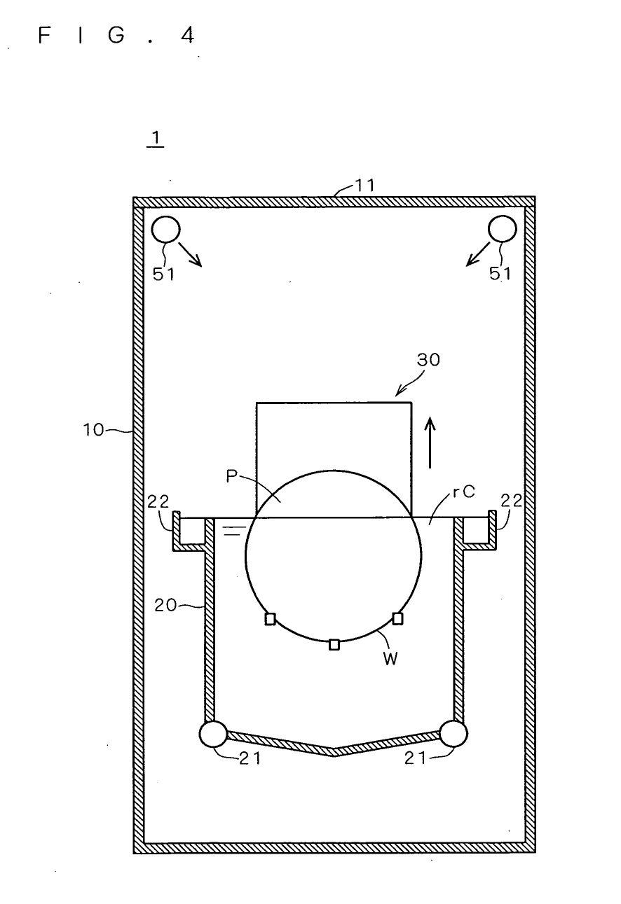

FIGS. 3 to 5 each illustrate the substrate processing apparatus 1 in each stage of processing. FIG. 3 shows a stage of surface cleaning with a rinse, FIG. 4 shows a stage of lifting substrates W out of the processing bath 20 after the cleaning with the rinse, and FIG. 5 shows a stage of drying using IPA which is an organic solvent. The operation of the substrate processing apparatus 1 proceeds under the control of the controller 80 exercised on the lifter driver 34, deionized-water valve 42, liquid chemical valve 402, gas valve 46, gas dissolver 44, IPA valve 53, nitrogen valve 55, drainage valve 61, exhaust valve 71, exhaust pump 72, and the like.

First, the lifter 30 receives a plurality of substrates W from a transfer robot provided outside the drawing, by which surface preparation on the substrates W in the substrate processing apparatus 1 is started. A fine pattern for an electronic circuit may be formed on the surface of each of the plurality of substrates W. Further, such pattern may be metal-surfaced.

Next, the lifter 30 moves down while simultaneously holding the plurality of substrates W, and the upper portion 11 of the chamber 10 is closed. At this time, the nitrogen valve 55 (cf. FIG. 1) is open, and a nitrogen gas is supplied from the gas supply nozzles 51. That is, the inside of the chamber 10 is in a nitrogen atmosphere. The subsequent surface cleaning of the substrates W with the liquid chemical and rinse proceeds in the nitrogen atmosphere.

When the plurality of substrates W reach the immersed position L shown in FIG. 3, the lifter 30 stops while securely holding the plurality of substrates W. At this time, the liquid chemical valve 402 (cf. FIG. 1) is open, and the liquid chemical is retained in the processing bath 20. Further, the processing liquid discharge nozzles 21 continue supplying the liquid chemical, and the liquid chemical continues overflowing from the upper opening of the processing bath 20 into the external baths 22. That is, the plurality of substrates W are held securely while being immersed in the liquid chemical retained in the processing bath 20. The supply of liquid chemical into the processing bath 20 may be started at the time when the plurality of substrates W are held securely in the immersed position L.

Continuing supplying the liquid chemical from the processing liquid discharge nozzles 21 into the processing bath 20 while maintaining the plurality of substrates W immersed in the liquid chemical retained in the processing bath 20, the surface cleaning of the substrates W with the liquid chemical is achieved. When carrying out the cleaning with a plurality of types of liquid chemicals, such various types of liquid chemicals are supplied into the processing bath 20 in a predetermined order. When the surface cleaning of the substrates W with the liquid chemical is finished, the drainage valve 61 (cf. FIG. 1) is opened to drain the liquid chemical retained in the processing bath 20.

When the drainage of the liquid chemical in the processing bath 20 is completed, then, the deionized-water valve 42 (cf. FIG. 1) and gas valve 46 (cf. FIG. 1) are opened to supply the carbon-dioxide-dissolved rinse rC from the discharge nozzles 21 into the processing bath 20. Specifically, as shown in FIG. 3, the carbon-dioxide-dissolved rinse rC is retained in the processing bath 20 and the carbon-dioxide-dissolved rinse rC is kept overflowing from the upper opening of the processing bath 20 into the external baths 22, while maintaining the plurality of substrates W in the immersed position L, as shown in FIG. 3. The carbon-dioxide-dissolved rinse rC may have a Carbon dioxide concentration of, e.g., 300 ppm.

Continuously supplying the carbon-dioxide-dissolved rinse rc into the processing bath 20 while maintaining the plurality of substrates W immersed in the carbon-dioxide-dissolved rinse rC retained in the processing bath 20, the surface cleaning of the substrates W with the rinse is achieved. Dissolving carbon dioxide in deionized water does not degrade the rinsing capability of deionized water, but achieves the same cleaning effect as deionized water as a rinse for removing the liquid chemical.

When the surface cleaning of the substrates W with the rinse is finished, the lifter 30 moves up while simultaneously holding the plurality of substrates W as shown in FIG. 4. At this time, the nitrogen valve 55 (cf. FIG. 1) is closed, while the IPA valve 53 (cf. FIG. 1) is opened, so that the IPA gas is supplied from the gas supply nozzles 51 instead of the nitrogen gas. In other words, the nitrogen gas atmosphere in the chamber 10 is replaced with the IPA gas atmosphere.

While the lifter 30 lifts the substrates W out of the carbon-dioxide-dissolved rinse rC retained in the processing bath 20 to be brought into the IPA gas atmosphere, IPA is condensed on a portion of the surface of each of the substrates W coming out of the liquid surface. That is, the carbon-dioxide-dissolved rinse rC adhered to the surface portion P is replaced with IPA.

Studies made by the inventors of the present invention have confirmed that the use of carbon-dioxide-dissolved deionized water as a rinse decreases the amount of rinse remaining between traces on a fine pattern formed on substrates when lifting the substrates after the cleaning with the rinse, as compared to the case of using deionized water as a rinse. It has also been confirmed that an unevenly remaining rinse is less likely to occur. Accordingly, in the present preferred embodiment using the carbon-dioxide-dissolved rinse rC as a rinse, the amount of carbon-dioxide-dissolved rinse rC remaining between traces on the pattern formed on the surface portion P is smaller, and an unevenly remaining rinse is less likely to occur, than in the case of using deionized water as a rinse.

Instead of lifting substrates W, the liquid surface in the processing bath 20 may be lowered to thereby relatively raise the substrates W from the liquid surface of the carbon-dioxide-dissolved rinse rC so that they are exposed in the IPA atmosphere. Specifically, the drainage valve 61 (cf. FIG. 1) may be opened with the substrates W kept in the immersed position L to drain the carbon-dioxide-dissolved rinse rC in the processing bath 20, and the substrates W may be lifted by the lifter 30 after the substrates W are exposed. In that case, the amount of rinse remaining between traces on the pattern formed on the surface of each of the substrates W exposed from the rinse is also smaller than in the case of using deionized water as a rinse.

When the plurality of substrates W reach the raised position H shown in FIG. 5, the lifter 30 stops while securely holding the plurality of substrates W. Subsequently, the exhaust pump 72 is driven with the exhaust valve 71 (cf. FIG. 1) kept open to exhaust the atmosphere inside the chamber 10, to thereby reduce the pressure inside the chamber 10.

Reducing the pressure inside the chamber 10 rapidly vaporizes IPA condensed on the surface of the substrates W held in the raised position H, so that the surface of each of the substrates W is dried.

Here, since an unevenly remaining rinse between traces on a pattern when lifted out of the rinse, e.g., an unevenly remaining rinse between cylinder-type capacitors is less likely to occur, the falling-down of the cylinders is less likely to occur in the drying step.

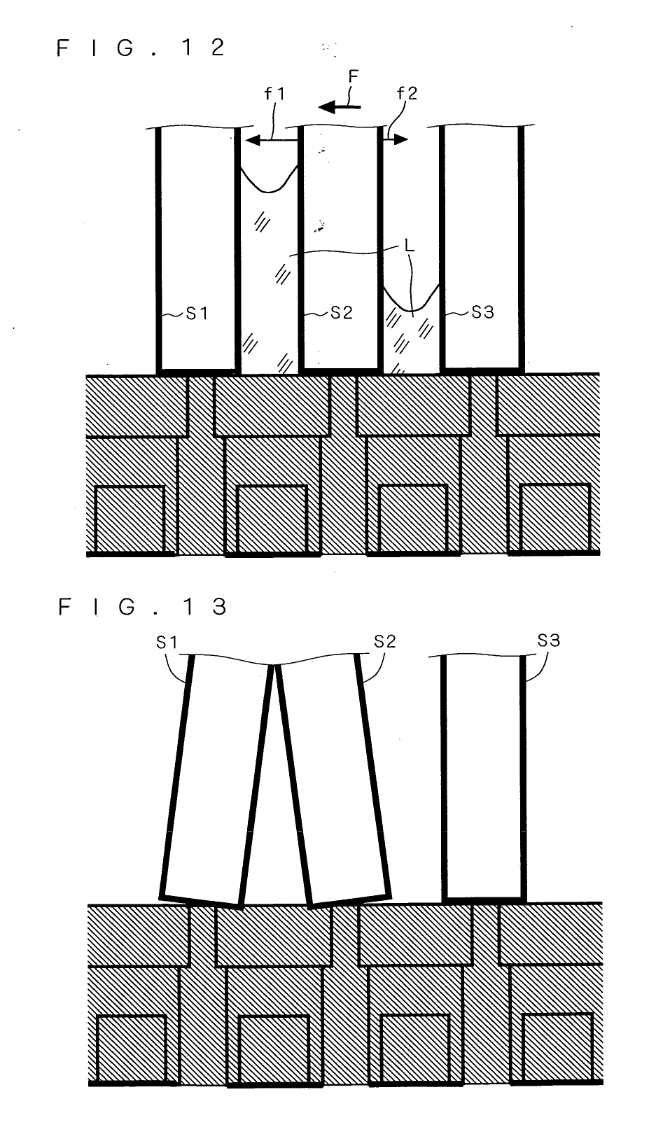

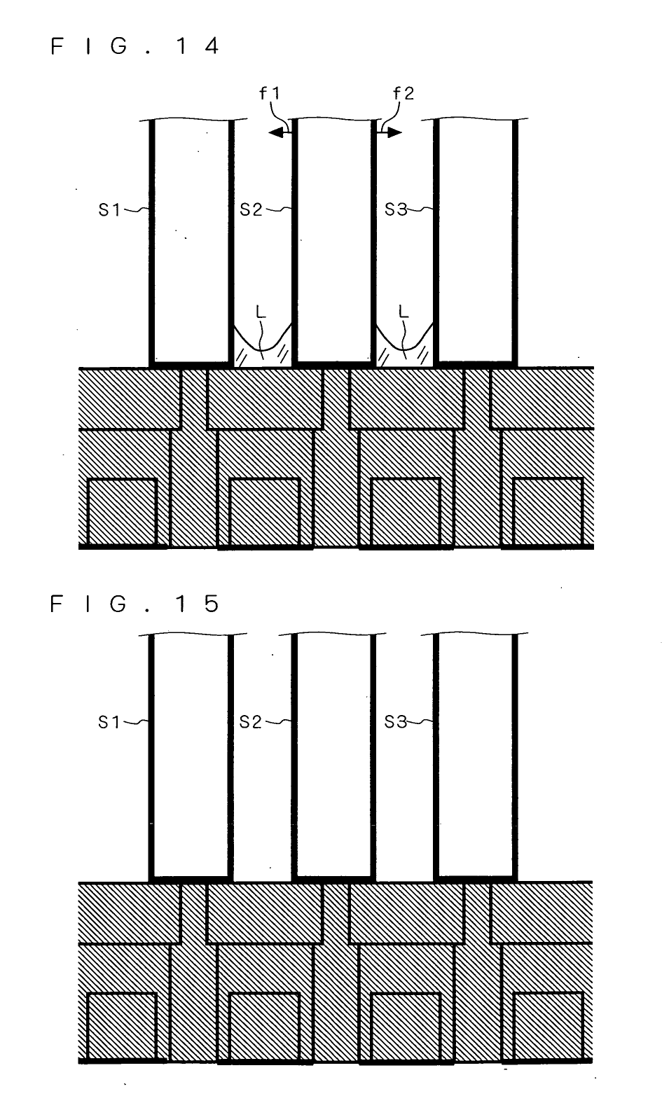

More specifically, lifting the substrates W out of the carbon-dioxide-dissolved rinse rC brings about the state as shown in FIG. 14, with the unlikelihood of occurrence of the unevenly remaining rinse as shown in FIG. 12 between the cylinder-type capacitors S1, S2 and S3 formed on each of the substrates W. Accordingly, the forces f1 and f2 resulting from the surface tension decrease, and the force F biased in a specific direction as a composite of the forces f1 and f2 is less likely to occur. Therefore, as shown in FIG. 15, the cylinders do not fall down in the drying step. Studies made by the inventors of the present invention have confirmed that the use of carbon-dioxide-dissolved deionized water as a rinse reduces the number of falling-down cylinders to about 1 per chip, while the use of deionized water as a rinse causes about 20 cylinder-type capacitors per chip to fall down. In short, it can be said that the use of carbon-dioxide-dissolved deionized water as a rinse reduces the falling-down of cylinders by about 95%.

Further, since the amount of rinse remaining in trench-type capacitors when lifting substrates W out of the rinse is small, poor drying in trenches is less likely to occur. That is, problems resulting from remaining water between traces on a pattern in the drying step are less likely to occur.

When the drying step is finished, the lifter 30 transfers the substrates W held in the raised position H to the transfer robot provided outside the drawing. The surface preparation on the substrates W in the substrate processing apparatus 1 is thereby finished.

### Second Preferred Embodiment

2-1. Construction of Substrate Processing Apparatus 2

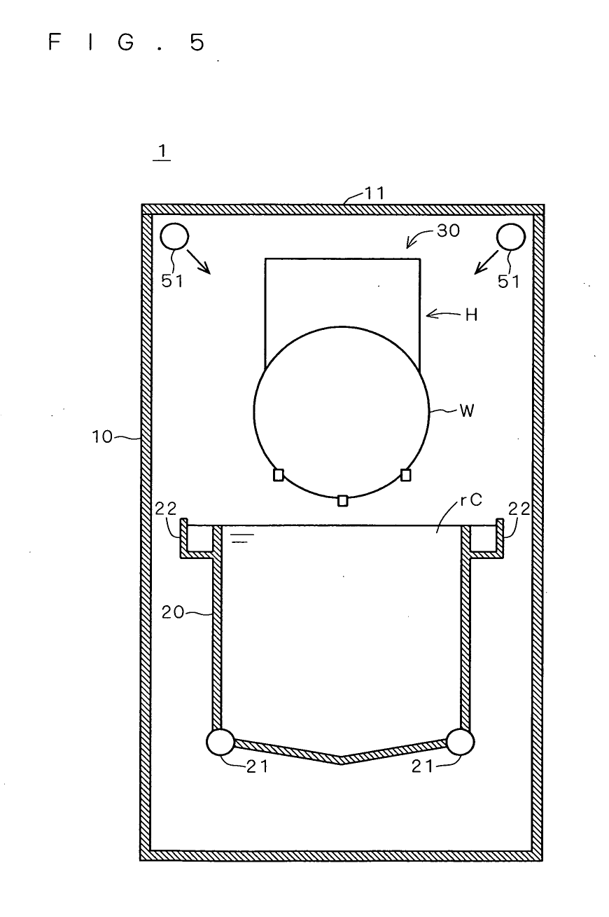

A second preferred embodiment describes the application of the present invention to a single-substrate processing apparatus. FIG. 6 is a vertical sectional view illustrating a substrate processing apparatus 2 according to the second preferred embodiment. FIG. 6 also shows piping and the structure of a control system.

The substrate processing apparatus 2 is an apparatus for carrying out surface cleaning with the carbon-dioxide-dissolved rinse rC on a substrate W having been treated with a liquid chemical, and then drying the substrate W using IPA which is an organic solvent, and mainly includes a substrate holder 110, a processing liquid supply system 120a, a gas supply system 130, a rinse recovery unit 140 and a controller 150.

The substrate holder 110 has a disc-shaped base material 111 and a plurality of chuck pins 112 provided upright on the upper surface of the base material 111. There are three or more chuck pins 112 provided along the peripheral edge of the base material 111 to hold a circular substrate W. The substrate W is placed on substrate supporting parts 112a of the plurality of chuck pins 112 and is held with its outer edge being pressed against chucks 112b. A rotary shaft 113 is provided perpendicularly at the center on the underside of the base material 111. The lower end of the rotary shaft 113 is coupled to an electric motor 114. Driving the electric motor 114 integrally rotates the rotary shaft 113, the base material 111, and the substrate W held on the base material 111 in a horizontal plane.

The processing liquid supply system 120a is piping for supplying a rinse onto the upper surface of the substrate W, and includes a processing liquid discharge nozzle 121, a deionized-water supply source 122, a deionized-water valve 123, a pipe 124, a gas dissolver 125, a carbon dioxide supply source 126, a gas valve 127 and a pipe 128. The pipe 124 with the deionized-water valve 123 interposed therein extends from the deionized-water supply source 122, and is connected to the processing liquid discharge nozzle 121 provided toward the upper surface of the substrate W. The gas dissolver 125 is interposed in the pipe 124 downstream of the deionized-water valve 123. The pipe 128 with the gas valve 127 interposed therein extends from the carbon dioxide supply source 126, and is connected to the gas dissolver 125.

In such construction, opening the deionized-water valve 123 introduces deionized water supplied from the deionized-water supply source 122 into the gas dissolver 125. Opening the gas valve 127 introduces carbon dioxide into the gas dissolver 125. The gas dissolver 125 dissolves the supplied carbon dioxide in deionized water supplied through the pipe 124 by the application of pressure, to thereby generate a carbon-dioxide-dissolved rinse rC. The generated carbon-dioxide-dissolved rinse rC is supplied to the processing liquid discharge nozzle 121 through the pipe 124.

The gas supply system 130 is piping for supplying an IPA gas onto the upper surface of the substrate W, and includes a gas supply nozzle 131, an IPA supply source 132, an IPA valve 133, and a pipe 134. The pipe 134 with the IPA valve 133 interposed therein extends from the IPA supply source 132, and is connected to the gas supply nozzle 131. In such construction, opening the IPA valve 133 discharges the IPA gas from the gas supply nozzle 131 provided toward the upper surface of the substrate W, so that the IPA gas is supplied onto the upper surface of the substrate W.

The rinse recovery unit 140 is a member for recovering a processing liquid supplied onto the upper surface of the substrate W, and includes a guard member 141 which surrounds the periphery of the substrate W held on the base material 111. The guard member 141 has a cross-sectional shape of inclining upwardly and inwardly with an opening at its center, and receives the rinse scattered around from the substrate W on its inner wall. The guard member 141 has a drain port 142 in part of its bottom surface. The rinse received on the guard member 141 reaches the drain port 142 along the inner wall of the guard member 141 and is drained to a drain line via the drain port 142.

The controller 150 is electrically connected to the chuck pins 112, electric motors 114, deionized-water valve 123, gas dissolver 125, gas valve 127, IPA valve 133, and the like, for controlling their operations.

2-2. Substrate Processing of Substrate Processing Apparatus 2

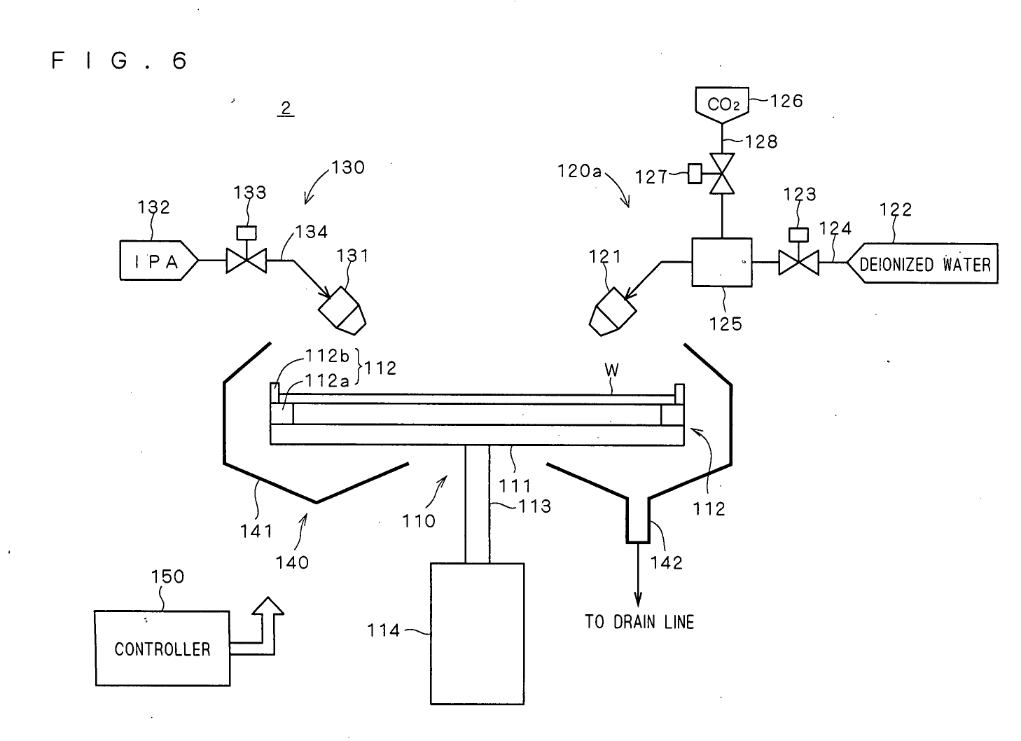

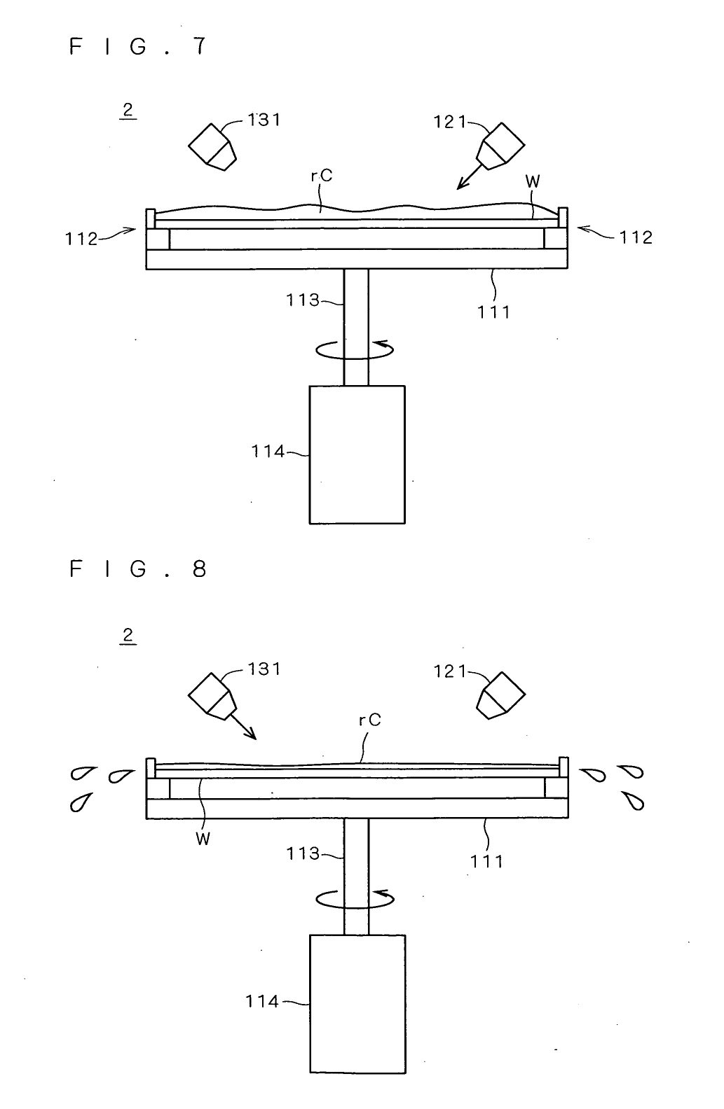

FIGS. 7 to 9 each illustrate the substrate processing apparatus 2 in each stage of processing. FIG. 7 shows a stage of surface cleaning with a rinse, FIG. 8 shows a stage just after the surface cleaning with the rinse, and FIG. 9 shows a stage of drying using IPA which is an organic solvent. The operation of the substrate processing apparatus 2 proceeds under the control of the controller 150 exercised on the chuck pin 112, electric motor 114, deionized-water valve 123, gas dissolver 125, gas valve 127, IPA valve 133, and the like.

First, a substrate W having been subjected to the surface cleaning with a liquid chemical is placed on the base material 111 by a transfer robot provided outside the drawing. The substrate W placed on the base material 111 is grasped by the chuck pins 112. A fine pattern may be formed on the surface of the substrate W. Further, such pattern may be metal-surfaced.

Subsequently, the electric motor 114 is driven to rotate the substrate W with the base material 111 as well as to cause the processing liquid discharge nozzle 121 to discharge the carbon-dioxide-dissolved rinse rC as shown in FIG. 7. That is, the deionized-water valve 123 (cf. FIG. 6) and gas valve 127 (cf. FIG. 6) are opened, so that the carbon-dioxide-dissolved rinse rC generated in the gas dissolver 125 (cf. FIG. 6) is supplied to the processing liquid discharge nozzle 121.

The carbon-dioxide-dissolved rinse rC discharged onto the upper surface of the substrate W flows toward the periphery of the substrate W by centrifugal force caused by the rotation of the substrate W to spread across the upper surface of the substrate W. The upper surface of the substrate W is thereby cleaned. The number of revolutions of the substrate W in the cleaning step is, e.g., 1000 rpm.

When the surface cleaning with the rinse is finished, the IPA gas is discharged from the gas supply nozzle 131 as shown in FIGS. 8 and 9 to bring the upper surface of the substrate W into the IPA gas atmosphere. That is, the IPA valve 133 (cf. FIG. 6) is opened, so that the IPA gas is supplied to the gas supply nozzle 131. Here, the electric motor 114 is also driven to rotate the substrate W with the base material 111. The number of revolutions of the substrate W in the drying step is, e.g., 1000 rpm.

At this time, the carbon-dioxide-dissolved rinse rC on the upper surface of the substrate W is forced to the outside by centrifugal force caused by the rotation of the substrate W and, after received by the guard member 141 (cf. FIG. 6), drained to the drain line via the drain port 142 (cf. FIG. 6). At the same time, IPA condenses on the surface of the substrate W. That is, droplets of the carbon-dioxide-dissolved rinse rC not forced to the outside but remaining on the upper surface of the substrate W are replaced by IPA. With volatilization of condensed IPA, the surface of the substrate W is dried.

Studies made by the inventors of the present invention have confirmed that the use of carbon-dioxide-dissolved deionized water as a rinse decreases the amount of rinse remaining between traces on a fine pattern formed on a substrate after the cleaning with the rinse, as compared to the case of using deionized water as a rinse. It has also been confirmed that an unevenly remaining rinse is less likely to occur. Accordingly, in the present preferred embodiment using the carbon-dioxide-dissolved rinse rC as a rinse, the amount of carbon-dioxide-dissolved rinse rC not forced to the outside but remaining between traces on the pattern formed on the surface of the substrate W after the cleaning with the rinse is smaller, and an unevenly remaining rinse is less likely to occur, than in the case of using deionized water as a rinse and rotating a substrate by the same number of revolutions. Therefore, problems resulting from remaining water between traces on a pattern in the drying step, such as poor drying in trenches, are less likely to occur.

When the drying step is finished, the electric motor 114 is driven to stop the rotation of the substrate W. The surface preparation on the substrate W in the substrate processing apparatus 2 is thereby finished.

2-3. Modification

The above-described substrate processing apparatus 2 only carries out surface cleaning with a rinse as final cleaning for finishing on a substrate W having been subjected to the surface cleaning with the liquid chemical, however, the substrate processing apparatus 2 may be constructed to carry out therein the surface cleaning with the liquid chemical. In that case, the processing liquid supply system 120a may additionally be provided with a liquid chemical supply source (not shown) for supplying a liquid chemical for cleaning a substrate W. For instance, a pipe with a liquid chemical valve (not shown) interposed therein extending from the liquid chemical supply source is connected to the processing liquid discharge nozzle 121. Accordingly, the liquid chemical can be supplied from the processing liquid discharge nozzle 121, which allows the surface cleaning with the liquid chemical.

Further, a nitrogen gas may be supplied from the gas supply nozzle 131 during the surface cleaning. In that case, the gas supply system 130 may be additionally be provided with a nitrogen supply source (not shown). For instance, a pipe with a nitrogen valve (not shown) interposed therein extending from the nitrogen supply source is connected to the gas supply nozzle 131. Accordingly, the nitrogen gas can be supplied from the gas supply nozzle 131, which allows the surface cleaning of the substrate W to be performed in the nitrogen atmosphere.

### Third Preferred Embodiment

3-1. Construction of Substrate Processing Apparatus

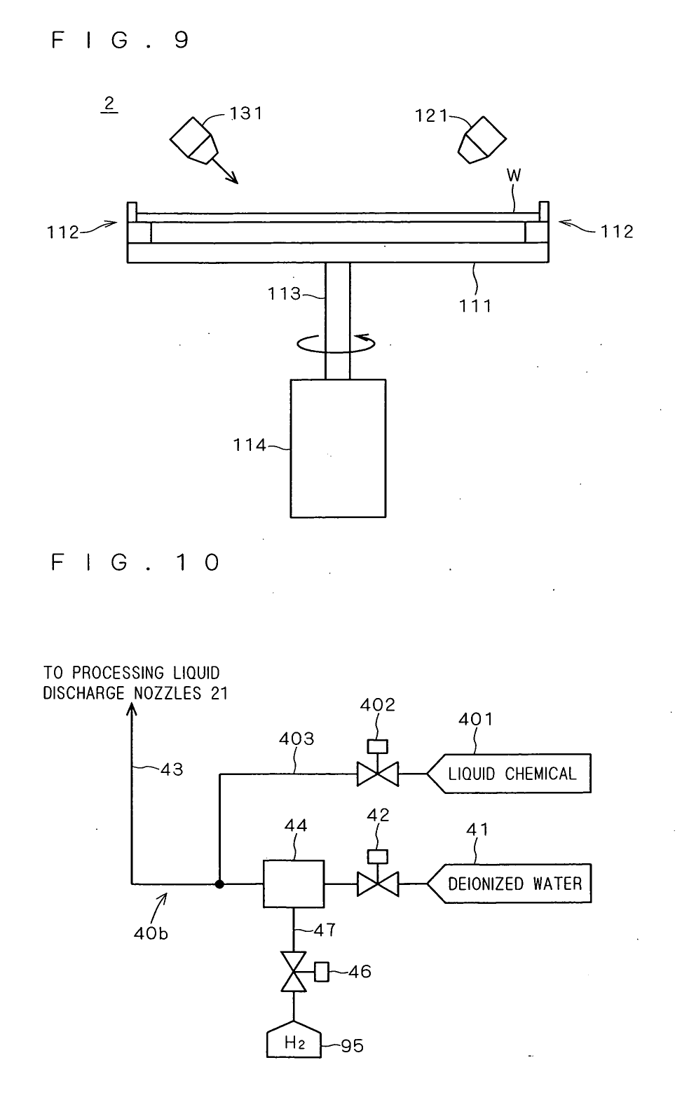

A third preferred embodiment describes the application of the present invention to a batch-type substrate processing apparatus, similarly to the first preferred embodiment. FIG. 10 illustrates a processing liquid supply system 40b of a substrate processing apparatus according to the third preferred embodiment. Components similar to those of the processing liquid supply system 40a of the substrate processing apparatus 1 according to the first preferred embodiment are indicated by the same reference numbers.

The substrate processing apparatus according to the present embodiment is an apparatus for treating substrates W with a liquid chemical, then carrying out final cleaning with a rinse for removing the liquid chemical from the substrates W, and thereafter drying the substrates W using IPA which is an organic solvent, but differs from the substrate processing apparatus 1 in that the final cleaning is carried out using a hydrogen-dissolved deionized water as a rinse.

The construction of the substrate processing apparatus according to the third preferred embodiment is almost the same as that of the substrate processing apparatus 1 according to the first preferred embodiment, except that the processing liquid supply system 40b shown in FIG. 10 is provided as piping for supplying a rinse to the processing liquid discharge nozzles 21. The processing liquid supply system 40b has almost the same construction as the processing liquid supply system 40a in the substrate processing apparatus 1, but has a hydrogen supply source 95 instead of the carbon dioxide supply source 45.

In the processing liquid supply system 40b of such construction, opening the deionized-water valve 42 introduces deionized water supplied from the deionized-water supply source 41 into the gas dissolver 44. Opening the gas valve 46 introduces hydrogen into the gas dissolver 44. The gas dissolver 44 dissolves the supplied hydrogen in deionized water supplied through the pipe 43 by the application of pressure, to thereby generate a rinse. This rinse (hereinafter referred to as “hydrogen-dissolved rinse rH”) generated by dissolving hydrogen in deionized water is supplied to the processing liquid discharge nozzles 21 through the pipe 43. Some of the various modifications described in the first preferred embodiment that do not contradict the construction of the present embodiment are also applicable to the present embodiment.

3-2. Substrate Processing of Substrate Processing Apparatus

A substrate processing operation of the substrate processing apparatus according to the third preferred embodiment is almost the same as that of the substrate processing apparatus 1 according to the first preferred embodiment, except that the hydrogen-dissolved rinse rH is used as a rinse instead of the carbon-dioxide-dissolved rinse rC. The hydrogen-dissolved rinse rH used as a rinse has a hydrogen concentration of, e.g., 1 ppm.

In the surface cleaning with the hydrogen-dissolved rinse rH, dissolving hydrogen in deionized water does not degrade the rinsing capability of deionized water, but achieves the same cleaning effect as deionized water as a rinse for removing a liquid chemical.

Studies made by the inventors of the present invention have confirmed that the use of hydrogen-dissolved deionized water as a rinse decreases the amount of rinse remaining between traces on a fine pattern formed on substrates when lifting the substrates after the cleaning with the rinse, as compared to the case of using deionized water as a rinse. It has also been confirmed that an unevenly remaining rinse is less likely to occur. Accordingly, in the present preferred embodiment using the hydrogen-dissolved rinse rH as a rinse, the amount of hydrogen-dissolved rinse rH remaining between traces on the pattern formed on the surface of each of substrates W is smaller, and an unevenly remaining rinse is less likely to occur, than in the case of using deionized water as a rinse. As a result, problems resulting from remaining water between traces on a pattern in the drying step, such as the falling-down of cylinders and poor drying in trenches, are less likely to occur.

### Fourth Preferred Embodiment

4-1. Construction of Substrate Processing Apparatus

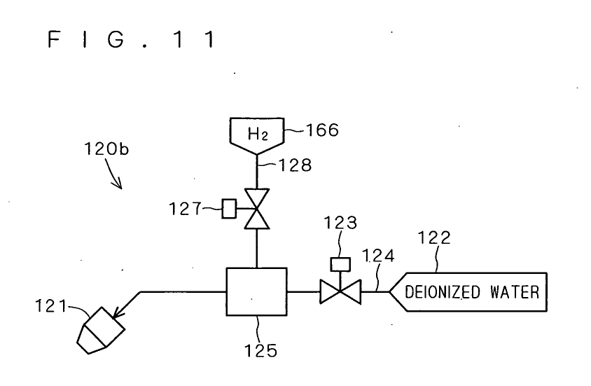

A fourth preferred embodiment describes the application of the present invention to a single-substrate processing apparatus, similarly to the second preferred embodiment. FIG. 11 illustrates a processing liquid supply system 120b of a substrate processing apparatus according to the fourth preferred embodiment. Components similar to those of the processing liquid supply system 120a of the substrate processing apparatus 2 according to the second preferred embodiment are indicated by the same reference numbers.

The substrate processing apparatus according to the present embodiment is an apparatus for carrying out surface cleaning with the hydrogen-dissolved rinse rH on a substrate W having been treated with a liquid chemical, and then drying the substrate W using IPA which is an organic solvent, and has almost the same construction as that of the substrate processing apparatus 2 according to the second preferred embodiment, except that the processing liquid supply system 120b shown in FIG. 11 is provided as piping for supplying a rinse on the upper surface of the substrate W. The processing liquid supply system 120b has almost the same construction as that of the processing liquid supply system 120a in the substrate processing apparatus 2, but has a hydrogen supply source 166 instead of the carbon dioxide supply source 126.

In the processing liquid supply system 120b of such construction, the hydrogen-dissolved rinse rH can be supplied to the processing liquid discharge nozzle 121. Some of the various modifications described in the second preferred embodiment that do not contradict the construction of the present embodiment are also applicable to the present embodiment.

4-2. Substrate Processing of Substrate Processing Apparatus

A substrate processing operation of the substrate processing apparatus according to the fourth preferred embodiment is almost the same as that of the substrate processing apparatus 2 according to the second preferred embodiment, except that the hydrogen-dissolved rinse rH is used as a rinse instead of the carbon-dioxide-dissolved rinse rC.

Studies made by the inventors of the present invention have confirmed that the use of hydrogen-dissolved deionized water as a rinse decreases the amount of rinse remaining between traces on a fine pattern formed on a substrate after the cleaning with the rinse, as compared to the case of using deionized water as a rinse. It has also been confirmed that an unevenly remaining rinse is less likely to occur. Accordingly, in the present preferred embodiment using the hydrogen-dissolved rinse rH as a rinse, the amount of hydrogen-dissolved rinse rH not forced to the outside but remaining between traces on the pattern formed on a substrate W is smaller, and an unevenly remaining rinse is less likely to occur, than in the case of using deionized water as a rinse and rotating the substrate by the same number of revolutions. Therefore, problems resulting from remaining water between traces on a pattern in the drying step, such as poor drying in trenches, are less likely to occur.

5. Other Modification

Although the IPA gas is used for drying as a gaseous organic solvent in the above-described preferred embodiments, gas of other alcohol, for example, may be used for drying as a gaseous organic solvent instead of the IPA gas.

The first and third preferred embodiments each have described a so-called one-bath type substrate processing apparatus for carrying out the liquid chemical treatment and the final cleaning with a rinse in one processing bath, however, the technique according to the present invention is also applicable to a so-called multibath type substrate processing apparatus for carrying out the liquid chemical treatment and final cleaning of substrates with a rinse in different processing baths.

While the invention has been shown and described in detail, the foregoing description is in all aspects illustrative and not restrictive. It is therefore understood that numerous modifications and variations can be devised without departing from the scope of the invention.

What is claimed is:

1. A substrate processing apparatus for making surface preparation on a substrate, comprising:
a chamber being able to be sealed while holding a substrate therein;
a processing bath being provided in said chamber and being able to retain a rinse;
a rinse preparing element bringing a rinse obtained by dissolving carbon dioxide in deionized water to be retained in said processing bath;
a lifter holding and moving up and down the substrate between an immersed position in which the substrate is immersed in said rinse retained in said processing bath and a raised position above said processing bath in said chamber; and
a gaseous organic solvent supplier supplying a gaseous organic solvent into said chamber when relatively lifting the substrate having been subjected to surface cleaning with said rinse in said processing bath from a liquid surface of said rinse with the substrate being held by said lifter.

2. The substrate processing apparatus according to claim 1, further comprising:
a drainage draining said rinse retained in said processing bath with the substrate being held by said lifter in said immersed position.

3. The substrate processing apparatus according to claim 1, wherein said gaseous organic solvent is isopropyl alcohol.

4. The substrate processing apparatus according to claim 1, wherein
said rinse obtained by dissolving carbon dioxide in deionized water has a Carbon dioxide concentration of 300 ppm.

5. A substrate processing apparatus for making surface preparation on a substrate, comprising:
a holding mechanism holding a substrate;
a rotation driving source rotating said holding mechanism to thereby rotate the substrate held by said holding mechanism;
a rinse supplier supplying a rinse obtained by dissolving carbon dioxide in deionized water to the substrate held by said holding mechanism; and
a gaseous organic solvent supplier supplying a gaseous organic solvent to the substrate held by said holding mechanism after surface cleaning of the substrate with said rinse is finished.

6. A substrate processing apparatus for making surface preparation on a substrate, comprising:
a chamber being able to be sealed while holding a substrate therein;
a processing bath being provided in said chamber and being able to retain a rinse;
a rinse preparing element bringing a rinse obtained by dissolving hydrogen in deionized water to be retained in said processing bath;
a lifter holding and moving up and down the substrate between an immersed position in which the substrate is immersed in said rinse retained in said processing bath and a raised position above said processing bath in said chamber; and
a gaseous organic solvent supplier supplying a gaseous organic solvent into said chamber when relatively lifting the substrate having been subjected to surface cleaning with said rinse in said processing bath from a liquid surface of said rinse with the substrate being held by said lifter.

7. The substrate processing apparatus according to claim 6, further comprising:
a drainage draining said rinse retained in said processing bath with the substrate being held by said lifter in said immersed position.

8. The substrate processing apparatus according to claim 6, wherein
said gaseous organic solvent is isopropyl alcohol.

9. The substrate processing apparatus according to claim 6, wherein
said rinse obtained by dissolving hydrogen in deionized water has a hydrogen concentration of 1 ppm.

10. A substrate processing apparatus for making surface preparation on a substrate, comprising:
a holding mechanism holding a substrate;
a rotation driving source rotating said holding mechanism to thereby rotate the substrate held by said holding mechanism;
a rinse supplier supplying a rinse obtained by dissolving hydrogen in deionized water to the substrate held by said holding mechanism; and
a gaseous organic solvent supplier supplying a gaseous organic solvent to the substrate held by said holding mechanism after surface cleaning of the substrate with said rinse is finished.

11. A substrate processing method for making surface preparation on a substrate, comprising the steps of:
(a) carrying out surface cleaning of a substrate with a rinse obtained by dissolving carbon dioxide in deionized water; and
(b) bringing the substrate having been subjected to said surface cleaning into an atmosphere of a gaseous organic solvent, thereby drying the substrate.

12. The substrate processing method according to claim 11, wherein
said step (a) includes the steps of:
(a-1) dissolving carbon dioxide in deionized water to generate said rinse; and
(a-2) retaining said rinse in a processing bath being able to retain a processing liquid to immerse the substrate in said rinse, and
said step (b) includes the steps of:
(b-1) supplying said gaseous organic solvent into a chamber having said processing bath provided therein, said chamber being able to be sealed; and
(b-2) relatively lifting the substrate immersed in said rinse retained in said processing bath from a liquid surface of said rinse.

13. The substrate processing method according to claim 11, wherein
said step (a) includes the steps of:
(a-1) dissolving carbon dioxide in deionized water to generate said rinse; and
(a-2) rotating the substrate while supplying said rinse to a surface of the substrate being rotated, and
said step (b) includes the steps of:
(b-1) rotating the substrate while supplying said gaseous organic solvent to the surface of the substrate being rotated.

14. A substrate processing method for making surface preparation on a substrate, comprising the steps of:
(a) carrying out surface cleaning of a substrate with a rinse obtained by dissolving hydrogen in deionized water; and
(b) bringing the substrate having been subjected to said surface cleaning into an atmosphere of a gaseous organic solvent, thereby drying the substrate.

15. The substrate processing method according to claim 14, wherein
said step (a) includes the steps of:
(a-1) dissolving hydrogen in deionized water to generate said rinse; and
(a-2) retaining said rinse in a processing bath being able to retain a processing liquid to immerse the substrate in said rinse, and
said step (b) includes the steps of:
(b-1) supplying said gaseous organic solvent into a chamber having said processing bath provided therein, said chamber being able to be sealed; and
(b-2) relatively lifting the substrate immersed in said rinse retained in said processing bath from a liquid surface of said rinse.

16. The substrate processing method according to claim 14, wherein said step (a) includes the steps of:
(a-1) dissolving hydrogen in deionized water to generate said rinse; and
(a-2) rotating the substrate while supplying said rinse to a surface of the substrate being rotated, and
said step (b) includes the steps of:
(b-1) rotating the substrate while supplying said gaseous organic solvent to the surface of the substrate being rotated.
